(19) United States
(12) Patent Application Publication
(10) Pub. No.: US 2006/0043637 A1
(43) Pub. Date: Mar. 2, 2006

(54) Methods of forming barrier rib microstructures with a mold

(75) Inventor: Thomas R.J. Corrigan, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/203,909

(22) Filed: Aug. 15, 2005

Related U.S. Application Data
(60) Provisional application No. 60/604,558, filed on Aug. 26, 2004.

(51) Int. Cl. B29C 59/02; B29C 71/02

(52) U.S. Cl. 264/236; 264/293

(57) ABSTRACT

In one embodiment the present invention relates to microstructured articles (e.g., barrier ribs formed by a method that comprises providing at least one discrete coating of slurry on a transfer sheet).

This application claims priority to U.S. patent application Ser. No. 60/604558 filed Aug. 26, 2004.

### BACKGROUND

Advancements in display technology, including the development of plasma display panels (PDPs) and plasma addressed liquid crystal (PALC) displays, have led to an interest in forming electrically-insulating inorganic barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which barrier ribs can be formed on glass substrates is by direct molding. This has involved laminating a planar rigid mold onto a substrate with a glass- or ceramic-forming composition disposed therebetween. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

Although various methods of making microstructures such as barrier ribs have been described, industry would find advantage in alternative methods.

### SUMMARY OF THE INVENTION

In one aspect, the invention relates to a method of making an article or component of an article having a microstructured surface (e.g. barrier ribs for a plasma display panel) comprising providing a transfer sheet, coating the transfer sheet with at least one discrete coating of a curable composition, transferring the discrete coating onto a substrate, contacting the discrete coating with a mold having a microstructured surface (e.g. suitable for forming barrier ribs), curing the curable composition, and removing the mold. The curable composition preferably comprises at least one inorganic particulate material, at least one curable organic binder, and at least one diluent.

The transfer sheet is preferably coated with at least two discrete coatings. The transfer sheet can be a substantially planar substrate or provided on a roll. Each discrete coating may have an area corresponding to a single plasma display panel (e.g. ranging from about 1 cm² to about 2m²). The transfer sheet may comprise a flexible film and a rigid support layer. The flexible film can be removed concurrently with removing the rigid support layer. The discrete coatings may be provided by use of a template. The mold is typically flexible and transparent. The curable material may be cured through the mold, through the glass panel, or a combination thereof. The method(s) are preferably at least semi-automated.

### BRIEF DESCRIPTION OF THE DRAWINGS

FIG. 1 is a schematic representation of a plasma display panel assembly.

FIG. 2 is an illustrative cross section of an embodied rigid support layer of a transfer sheet.

FIG. 3 is a side view showing an embodied method of employing a transfer sheet.

FIG. 4A-4D is an illustrative schematic representation of transferring a coating from a transfer sheet to a substrate in a rotational framework.

### DETAILED DESCRIPTION OF PREFERRED EMBODIMENTS

The present invention is believed to be applicable to methods of making microstructures on a substrate using a mold, as well as the articles made using the methods. In particular, the present invention is directed to making inroganic microstructures on a substrate using a mold. Plasma display panels (PDPs) can be formed using the methods and provide a useful illustration of the methods. It will be recognized that other devices and articles can be formed using these methods including, for example, electrophoresis plates with capillary channels and lighting applications. In particular, devices and articles that can utilize molded ceramic microstructures can be formed using the methods described herein. While the present invention is not so limited, an appreciation of various aspects of the invention will be gained through a discussion of the examples provided below.

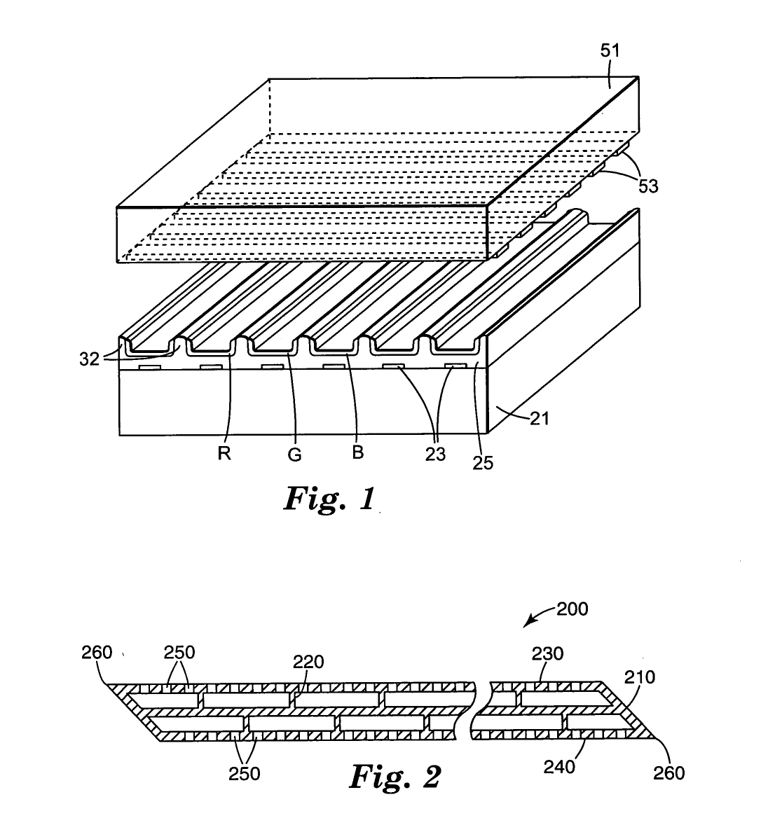

Plasma display panels (PDPs) have various components, as illustrated in FIG. 1. The back substrate, oriented away from the viewer, has independently addressable parallel electrodes 23. The back substrate 21 can be formed from a variety of compositions, for example, glass. Ceramic microstructures 25 are formed on the back substrate 21 and include barrier rib portions 32 that are positioned between electrodes 23 and separate areas in which red (R), green (G), and blue (B) phosphors are deposited. The front substrate includes a glass substrate 51 and a set of independently addressable parallel electrodes 53. These front electrodes 53, also called sustain electrodes, are oriented perpendicular to the back electrodes 23, also referred to as address electrodes. In a completed display, the area between the front and back substrate elements is filled with an inert gas. To light up a pixel, an electric field is applied between crossed sustain 53 and address electrodes 23 with enough strength to excite the inert gas atoms therebetween. The excited inert gas atoms emit ultraviolet (UV) radiation that causes the phosphor to emit red, green, or blue visible light.

Back substrate 21 is preferably a transparent glass substrate. Typically, for PDP applications back substrate 21 is made of soda lime glass that is optionally substantially free of alkali metals. The temperatures reached during processing can cause migration of the electrode material in the presence of alkali metal in the substrate. This migration can result in conductive pathways between electrodes, thereby shorting out adjacent electrodes or causing undesirable electrical interference between electrodes known as “crosstalk.” Front substrate 51 is typically a transparent glass substrate which preferably has the same or about the same coefficient of thermal expansion as that of the back substrate 21.

Electrodes 23, 53 are strips of conductive material. The electrodes 23 are formed of a conductive material such as, for example, copper, aluminum, or a silver-containing conductive frit. The electrodes can also be a transparent conductive material, such as indium tin oxide, especially in cases where it is desirable to have a transparent display panel. The electrodes are patterned on back substrate 21 and front substrate 51. For example, the electrodes can be formed as parallel strips spaced about 120 μm to 360 μm apart, having widths of about 50 μm to 75 μm, thicknesses of about 2 μm to 15 μm, and lengths that span the entire active display area which can range from a few centimeters to several tens of centimeters. In some instances the widths of the electrodes 23, 53 can be narrower than 50 μm or wider than 75 μm, depending on the architecture of the microstructures 25.

The height, pitch and width of the microstructured barrier rib portions 32 in PDPs can vary depending on the desired finished article. The pitch (number per unit length) of the barrier ribs preferably matches the pitch of the electrodes. The height of the barrier ribs is generally at least 100 μm and typically at least 150 μm. Further, the height is typically no greater than 500 μm and typically less than 300 μm. The pitch of the barrier rib pattern may be different in the longitudinal direction in comparison to the transverse direction. The pitch is generally at least 100 μm and typically at least 200 μm. The pitch is typically no greater than 600 μm and typically less than 400 μm. The width of the barrier rib pattern may be different between the upper surface and the lower surface, particularly when the barrier ribs thus formed are tapered. The width is generally at least 10 μm, and typically at least 50 μm. Further, the width is generally no greater than 100 μm and typically less than 80 μm.

When using the methods of the present invention to make microstructures on a substrate (such as barrier ribs for a PDP), the coating material from which the microstructures are formed is preferably a slurry or paste containing a mixture of at least three components. The first component is a glass or ceramic forming particulate inorganic material (e.g. a ceramic powder.) Generally, the particulate inorganic material of the slurry or paste is ultimately fused or sintered by firing to form microstructures having desired physical properties adhered to the patterned substrate. The second component is a binder (e.g., a fugitive binder) that is capable of being shaped and subsequently hardened by curing or cooling. The binder allows the slurry or paste to be shaped into semi-rigid green state microstructures that are adhered to the substrate. The third component is a diluent that can promote release from the mold after alignment and hardening of the binder material, and can promote fast and complete burn out of the binder during debinding before firing the ceramic material of the microstructures. The diluent preferably remains a liquid after the binder is hardened so that the diluent phase-separates from the binder during binder hardening. The slurry preferably has a viscosity of less than 20,000 cps and more preferably less than 5,000 cps to uniformly fill all the microstructured groove portions of the flexible mold without entrapping air.

The amount of curable organic binder in the curable paste composition is typically at least 2 wt-%, more typically at least 5 wt-%, and more typically at least 10 wt-%. The amount of diluent in the rib precursor composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive

In one embodiment the present invention relates to barrier ribs formed by a method that comprises providing at least one discrete coating of slurry on a transfer sheet.

The transfer sheet is a thin flexible film layer typically supported by a rigid (e.g. moveable) support layer. The flexible film may be peeled away from the slurry at a sharp angle defined by the edge of the rigid moveable support that is retracted across the surface of the glass panel. Suitable flexible films include polyethylene terephthalate, polycarbonate films, cellulose acetate butyrate, cellulose acetate propionate, polyether sulfone, polymethyl methacrylate, polyurethane, polyester, polyvinyl chloride, polyimide, polyolefins, polypropylene, polyethylene, and polycyclo-olefins.

The transfer sheet typically comprises a release coating that allows it to be peeled off leaving substantially all of the slurry on the glass panel. Release coatings typically used on plastic films include low-surface-energy organic materials including hydrocarbons, silicones, and fluorocarbons. Hydrocarbons can include oils, waxes, polyolefins, and polymers such as polyacrylates or polyurethanes bearing pendant alkyl segments. Silicones can include non-functionalized poly(dimethylsiloxane) fluids as well as silanol- or vinyl-functionalized polydimethylsiloxanes crosslinked by condensation or hydrosilation reactions, respectively. Fluorocarbons can include fluorochemical oils, perfluoropolyethers, fluoropolymers prepared by (co)polymerization of fluorinated olefins such as tetrafluoroethylene, vinylidene fluoride, and hexafluoropropylene, and polymers such as polyacrylates, polyurethanes, or polyepoxides bearing pendant fluorine-substituted alkyl groups. Particularly preferred classes of release materials are the perfluoropolyethers bearing curable functionalities such as acrylate, silane, or epoxy groups that can be crosslinked into robust coatings with low surface energies and good release properties toward a wide variety of organic materials such as resins and adhesives.

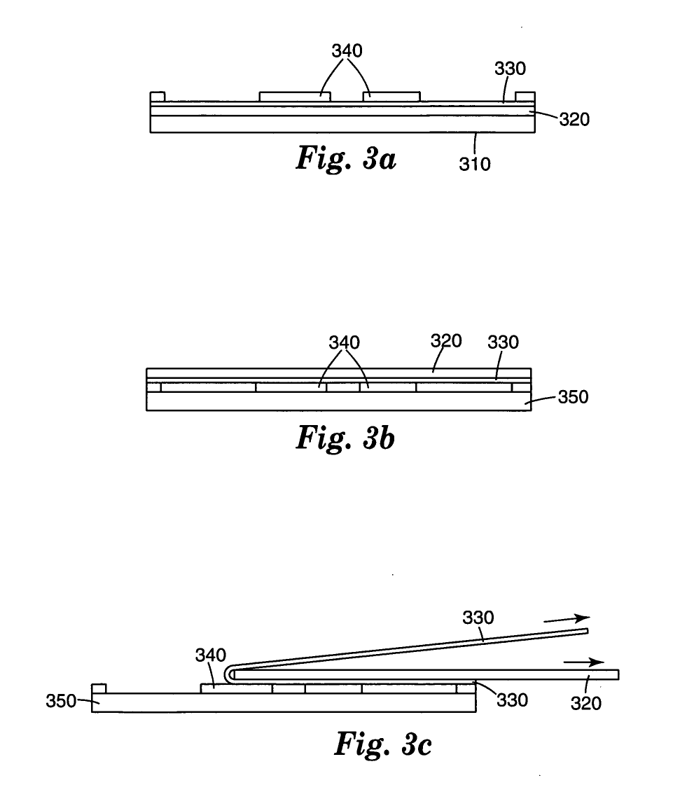

FIG. 2 depicts a cross section of an exemplary suitable rigid support 200. For example, a rigid support can be formed from an appropriately sized (e.g. 25 mm thick) aluminum plate 210 that is machined to a depth of 10 mm on both sides leaving grids of supporting ribs 220. A pair of (e.g. 5 mm thick) aluminum plates can be bonded to the supporting ribs 220 creating flat surfaces 230 and 240 on the top and bottom respectively. The edge 260 of the rigid support (i.e. at the location where the transfer film slides) is preferably angled at an amount of at least 30 degree and typically no greater than 90 degree, with a 45 degree taper typically being preferred. Further this edge of the rigid support typically has a radius of between 0 to 10 mm with a 0.50 mm radius being preferred.

The rigid support is equipped with a means of holding the transfer film closely to the rigid support surface and a means of releasing the transfer film surface. One suitable means includes providing (e.g. 100 p diameter) holes 250 at the top and bottom surfaces of the rigid support that are operably connected to a vaccum (not shown). Fittings (not shown) can be provided at the edges of the rigid support so the transfer film can selectively be pulled by vacuum to the top or bottom surfaces of the support. Valves (not shown) allow compressed air to alternately be introduced to the fittings so that the transfer film can move easily across either or both surfaces.

Coating the transfer sheet with one or more discrete coatings can be accomplished by use of a template as described is concurrently filed U.S. patent application Ser. No. 60/604557, filed Aug. 26, 2004. Alternatively, the discrete coatings may be produced by screen printing, transfer printing or other conventional methods capable of placing slurry in a specified region. Suitable methods are capable of coating the curable material to an accurate thickness in combination with proper edge definition. Regardless of the manner employed, the slurry is coated in a manner that minimizes the entrapments of air.

The glass panel with patterned electrodes is brought into contact with the coated transfer sheet such that the electrodes facing the slurry are aligned with the eventual barrier rib regions. This can be accomplished in a number of different ways.

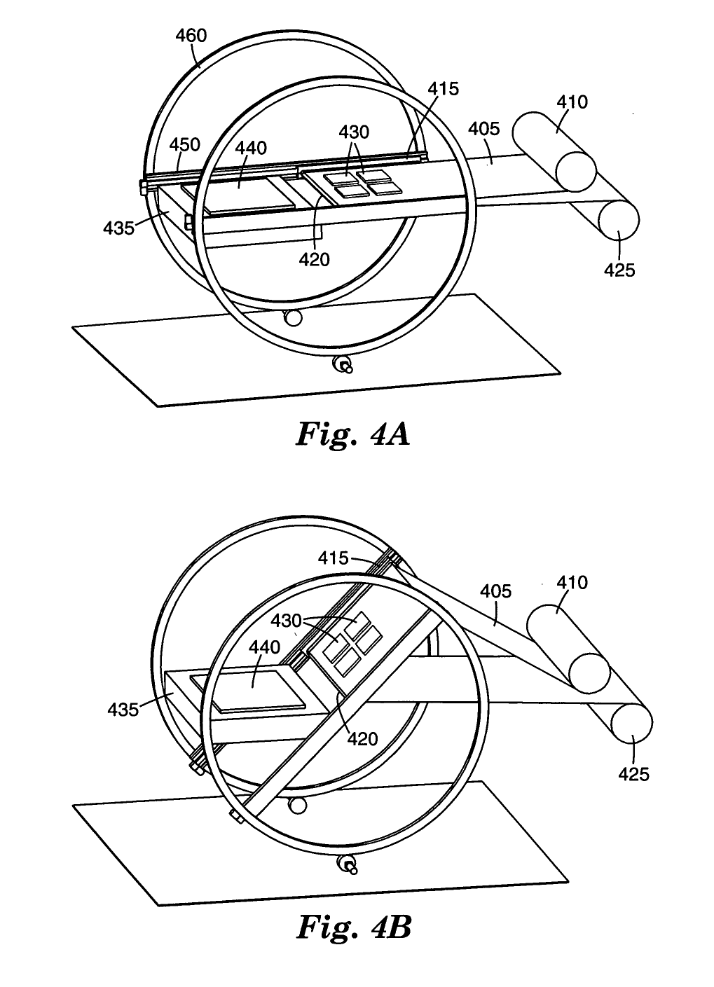

In one aspect, the transfer sheet may remain horizontal while the glass panel is inverted (i.e. electrodes down) on top of it. Then the glass panel and transfer sheet are together rotated so that the glass panel is on the bottom. With reference to FIG. 3a-3c, 3a depicts a cross-sectional view of a coating area having a flat surface 310 (e.g. table), a suitable rigid support 320, and transfer film 330. Discrete patches of slurry 340 are provided on the transfer film surface. Glass panel 350 is next placed (i.e. electrodes down) on the discrete patches of slurry (not shown). Next, the glass panel and transfer sheet are together rotated as depicted in FIG. 3b such that the glass panel is beneath the transfer sheet. The transfer sheet is then removed from the patches of slurry by concurrently pulling the rigid support 320 in a direction substantially parallel to the glass panel while removing the transfer sheet at an angle as depicted in 3c. The angle formed during the removal of the transfer sheet is typically at least 50 and no greater than about 90°.

In another aspect, the transfer sheet may be rotated and placed on top of the glass panel (i.e. slurry side of transfer sheet down). The transfer sheet is then removed leaving the slurry on the glass panel. This can be accomplished by means of transferring a coating from a transfer sheet to a patterned (e.g. glass panel) substrate in a rotational framework.

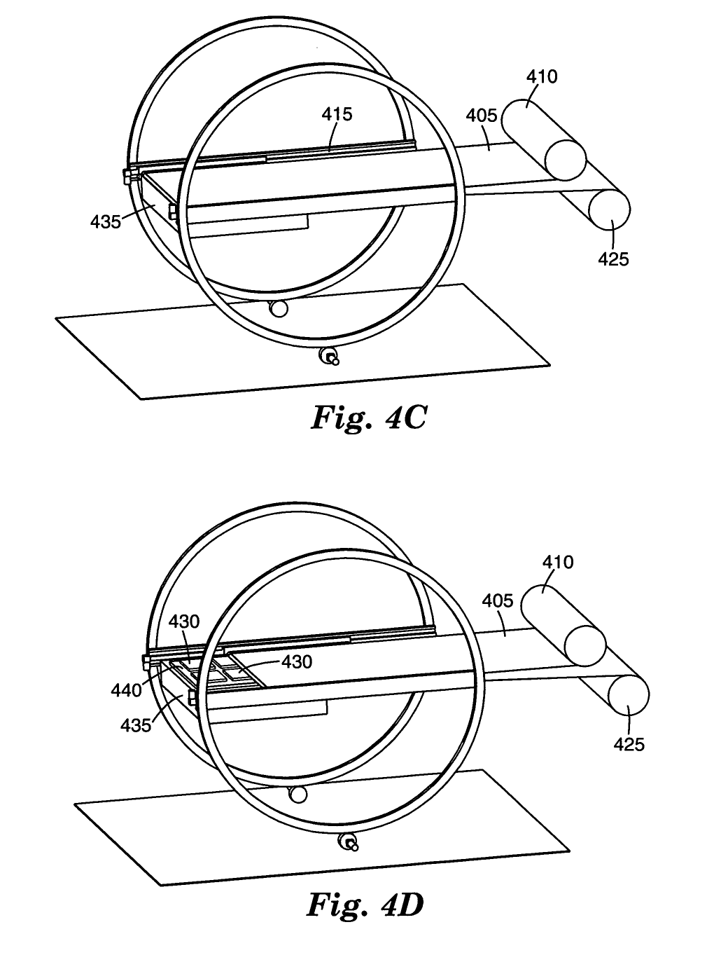

With reference to FIG. 4A-4D the transfer film 405 may be a continuous web that that is fed from roll 410, across the top surface of the rigid moveable support 415, around one edge 420 of the rigid moveable support, across the bottom surface and onto another roll 425. The rolls 410 and 425 that hold the transfer film can be mounted to ground and oriented so that the rolls can pull the film across the rigid moveable support. The rolls 410 and 425 may be both driven by servomotor systems (not shown) with encoders for feedback on the rotation of the rolls, and sensors to monitor the tension in the flexible film.

The rigid moveable support can be provided in a translational framework 450 capable of sliding the transfer sheet with a range of motion (e.g. 2-3 m). The translation may be accomplished by servomotors (not shown) driving a ballscrew actuator that contact hard stops at the two extreme locations. The translational framework may be mounted inside a rotational framework 460 that has a full continuous 360 degrees of motion. The rotational framework is capable of rotating the transfer sheet from a coating area with the coated surface of the transfer film facing up, to a laminating area (such as a flat granite surface) that is in the plane of the coating area with the coated surface of the transfer film facing down.

A robotic part handling system (not shown) can provide a glass substrate 440 having electrode-patterned regions to a flat surface 435 in the laminating area with the electodes facing up. A vision system guides the motion of the robot to orient the electrode regions with the patches of slurry as the glass panel is placed. The rotational framework rotates the transfer sheet and slurry onto the glass substrate on the flat (e.g. granite) surface 435 of the laminating area.

With reference to FIG. 4B, constant tension can be maintained on the transfer film to convey the film to allow for such motion of the transfer sheet. With reference to FIGS. 4C and 4D, after the slurry contact the glass panel the vacuum is replaced with low pressure compressed air (20-30 psi) and the translational framework slides the transfer sheet horizontally back to the coating area. While the translational framework slides, the lower film roll holds its position, while the upper film roll applies constant tension to pull the transfer film across both surfaces of the rigid moveable support. When the transfer film reaches the coating area it will have an uncoated length of film on the top surface ready for coating.

Alternatively, the glass substrate 440 can be placed, electrodes-facing down, on the coated slurry. Clamps mounted to the translational framework can hold the glass substrate to the transfer sheet as the rotational framework rotates the stack of transfer sheet, slurry, and glass substrate onto the flat surface 435 of the laminating area.

Regardless of the manner in which the slurry has been transferred from the transfer sheet onto to the glass panel, the microstructured surface of the mold (e.g. suitable for making barrier ribs) is then contacted with the patches of slurry such that the electrode pattern of the glass panel is aligned with the microstructure pattern of the mold. The slurry is sufficiently cured (e.g. by exposure to a light source through the mold) prior to removal of the mold. The resulting cured barrier ribs disposed on the glass panel are then sintered. After the slurry has been transferred onto the glass, the slurry can be contacted with the mold, cured, the mold removed, and sintered as previously described. The transfer sheet station can be employed to coat another glass substrate while the glass substrate that was just coated is being subject to the subsequent molding step.

The inorganic particulate material of the slurry or paste is chosen based on the end application of the microstructures and the properties of the substrate to which the microstructures will be adhered. One consideration is the coefficient of thermal expansion (CTE) of the substrate material. Preferably, the CTE of the inorganic material of the slurry, when fired, differs from the CTE of the substrate material by no more than about 10%. When the substrate material has a CTE which is much less than or much greater than the CTE of the inorganic material of the microstructures, the microstructures can warp, crack, fracture, shift position, or completely break off from the substrate during processing or use. Further, the substrate can warp due to a high difference in CTE between the substrate and the microstructures.

The substrate is typically able to withstand the temperatures necessary to process the inorganic material of the slurry or paste. Inorganic materials suitable for use in the slurry or paste preferably have softening temperatures of about 600° C. or less, and usually in the range of about 400° C. to 600° C. Thus, a preferred choice for the substrate is a glass, ceramic, metal, or other rigid material that has a softening temperature higher than that of the inorganic material of the slurry. Preferably, the substrate has a softening temperature that is higher than the temperature at which the microstructures are to be fired. If the material will not be fired, the substrate can also be made of materials, such as plastics. Inorganic materials suitable for use in the slurry or paste preferably have coefficients of thermal expansion of about 5×10⁻⁶/° C. to 13×10⁻⁶/° C. Thus, the substrate preferably has a CTE approximately in this range as well.

Choosing a inorganic material having a low softening temperature allows the use of a substrate also having a relatively low softening temperature. In the case of glass substrates, soda lime float glass having low softening temperatures is typically less expensive than glass having higher softening temperatures. Thus, the use of a low softening temperature inorganic material can allow the use of a less expensive glass substrate. The ability to fire green state barrier ribs at lower temperatures can reduce the thermal expansion and the amount of stress relief required during heating, thus avoiding undue substrate distortion, barrier rib warping, and barrier rib delamination.

Lower softening temperature ceramic materials can be obtained by incorporating certain amounts of alkali metals, lead, or bismuth into the material. However, for PDP barrier ribs, the presence of alkali metals in the microstructured barriers can cause material from the electrodes to migrate across the substrate during elevated temperature processing. The diffusion of electrode material can cause interference, or “crosstalk”, as well as shorts between adjacent electrodes, degrading device performance. Thus, for PDP applications, the ceramic powder of the slurry is preferably substantially free of alkali metal. When the incorporation of lead or bismuth is employed, low softening temperature ceramic material can be obtained using phosphate or B₂O₃-containing compositions. One such composition includes ZnO and B₂O₃. Another such composition includes BaO and B₂O₃. Another such composition includes ZnO, BaO, and B₂O₃. Another such composition includes La₂O₃ and B₂O₃. Another such composition includes Al₂O₃, ZnO, and P₂O₅.

Other fully soluble, insoluble, or partially soluble components can be incorporated into the ceramic material of the slurry to attain or modify various properties. For example, Al₂O₃ or La₂O₃ can be added to increase chemical durability of the composition and decrease corrosion. MgO can be added to increase the glass transition temperature or to increase the CTE of the composition. TiO₂ can be added to give the ceramic material a higher degree of optical opacity, whiteness, and reflectivity. Other components or metal oxides can be added to modify and tailor other properties of the ceramic material such as the CTE, softening temperature, optical properties, physical properties such as brittleness, and so on.

Other means of preparing a composition that can be fired at relatively low temperatures include coating core particles in the composition with a layer of low temperature fusing material. Examples of suitable core particles include ZrO₂, Al₂O₃, ZrO₂-SiO₂, and TiO₂. Examples of suitable low fusing temperature coating materials include B₂O₃, P₂O₅, and glasses based on one or more of B₂O₃, P₂O₅, and SiO₂. Th coatings can be applied by various methods. A preferred method is a sol-gel process in which the core particles are dispersed in a wet chemical precursor of the coating material. The mixture is then dried and comminuted (if necessary) to separate the coated particles. These particles can be dispersed in the glass or ceramic powder of the slurry or paste or can be used by themselves for the glass powder of the slurry or paste.

The inorganic material in the slurry or paste is preferably provided in the form of particles that are dispersed throughout the slurry or paste. The preferred size of the particles depends on the size of the microstructures to be formed and aligned on the patterned substrate. Preferably, the average size, or diameter, of the particles in the inorganic material of the slurry or paste is no larger than about 10% to 15% the size of the smallest characteristic dimension of interest of the microstructures to be formed and aligned. For example, PDP barrier ribs can have widths of about 20 μm, and their widths are the smallest feature dimension of interest. For PDP barrier ribs of this size, the average particle size in the inorganic material is preferably no larger than about 2 or 3 μm. By using particles of this size or smaller, it is more likely that the microstructures will be replicated with the desired fidelity and that the surfaces of the inorganic microstructures will be relatively smooth. As the average particle size approaches the size of the microstructures, the slurry or paste containing the particles may no longer conform to the microstructured profile. In addition, the maximum surface roughness can vary based in part on the inorganic particle size. Thus, it is easier to form smoother structures using smaller particles.

The binder of the slurry or paste is an organic binder chosen based on factors such as the ability to bind to the inorganic material of the slurry or paste, the ability to be cured or otherwise hardened to retain a molded microstructure, the ability to adhere to the patterned substrate, and the ability to volatilize (or burn out) at temperatures at least somewhat lower than those used for firing the green state microstructures. The binder helps bind together the particles of the inorganic material when the binder is cured or hardened so that the mold can be removed to leave rigid green state microstructures adhered to and aligned with the patterned substrate. The binder can be referred to as a “fugitive binder” because, if desired, the binder material can be burned out of the microstructures at elevated temperatures prior to fusing or sintering the ceramic material in the microstructures. Preferably, firing substantially completely burns out the fugitive binder so that the microstructures left on the patterned surface of the substrate are fused inorganic microstructures that are substantially free of carbon residue. In applications where the microstructures used are dielectric barriers, such as in PDPs, the binder is preferably a material capable of debinding at a temperature at least somewhat below the temperature desired for firing without leaving behind a significant amount of carbon that can degrade the dielectric properties of the microstructured barriers. For example, binder materials containing a significant proportion of aromatic hydrocarbons, such as phenolic resin materials, can leave graphitic carbon particles during debinding that can require significantly higher temperatures to completely remove.

The binder is preferably an organic material that is radiation or heat curable. Preferred classes of materials include acrylates and epoxies. Alternatively, the binder can be a thermoplastic material that is heated to a liquid state to conform to the mold and then cooled to a hardened state to form microstructures adhered to the substrate. When precise placement and alignment of the microstructures on the substrate is desired, it is preferable that the binder is radiation curable so that the binder can be hardened under isothermal conditions. Under isothermal conditions (no change in temperature), the mold, and therefore the slurry or paste in the mold, can be held in a fixed position relative to the pattern of the substrate during hardening of the binder material. This reduces the risk of shifting or expansion of the mold or the substrate, especially due to differential thermal expansion characteristics of the mold and the substrate, so that precise placement and alignment of the mold can be maintained as the slurry or paste is hardened.

When using a binder that is radiation curable, it is preferable to use a cure initiator that is activated by radiation to which the substrate is substantially transparent so that the slurry or paste can be cured by exposure through the substrate. For example, when the substrate is glass, the binder is preferably visible light curable. By curing the binder through the substrate, the slurry or paste adheres to the substrate first, and any shrinkage of the binder material during curing will tend to occur away from the mold and toward the surface of the substrate. This helps the microstructures demold and helps maintain the location and accuracy of the microstructure placement on the pattern of the substrate.

In addition, the selection of a cure initiator can depend on what materials are used for the inorganic material of the slurry or paste. For example, in applications where it is desirable to form ceramic microstructures that are opaque and diffusely reflective, it can be advantageous to include a certain amount of titania (TiO₂) in the ceramic material of the slurry or paste. While titania can be useful for increasing the reflectivity of the microstructures, it can also make curing with visible light difficult because visible light reflection by the titania in the slurry or paste can prevent sufficient absorption of the light by the cure initiator to effectively cure the binder. However, by selecting a cure initiator that is activated by radiation that can simultaneously propagate through the substrate and the titania particles, effective curing of the binder can take place. One example of such a cure initiator is bis(2,4,6-trimethylbenzoyl)-phenylphosphineoxide, a photoinitiator commercially available from Ciba Specialty Chemicals, Hawthrone, N.Y., under the trade designation “Irgacure 819”. Another example is a ternary photoinitiator system, as described in U.S. Pat. No. 5,545,670, incorporated herein by reference, including, for example, a mixture of ethyl dimethylaminobenzoate, camphoroquinone, and diphenyl iodonium hexafluorophosphate. Both of these examples are active in the blue region of the visible spectrum near the edge of the ultraviolet in a relatively narrow region where the radiation can penetrate both a glass substrate and titania particles in the slurry or paste. Other cure systems can be selected for use in the process of the present invention based on, for example, the binder, the components of the inorganic material in the slurry or paste, and the material of the mold or the substrate through which curing is to take place.

The diluent of the slurry or paste is generally a material selected based on factors such as, for example, the ability to enhance mold release properties of the slurry subsequent to curing the fugitive binder and the ability to enhance debinding properties of green state structures made using the slurry or paste. The diluent is preferably a material that is soluble in the binder prior to curing and remains liquid after curing the binder. By remaining a liquid when the binder is hardened, the diluent reduces the risk of the cured binder material adhering to the mold. Further, by remaining a liquid when the binder is hardened, the diluent phase separates from the binder material, thereby forming an interpenetrating network of small pockets, or droplets, of diluent dispersed throughout the cured binder matrix.

Various organic diluents can be employed depending on the choice of curable organic binder. In general suitable diluents include various alcohols and glycols such as alkylene glycol (e.g. ethylene glycol, propylene glycol, tripropylene glycol), alkyl diol (e.g. 1,3 butanediol,), and alkoxy alcohol (e.g. 2-hexyloxyethanol, 2-(2-hexyloxy)ethanol, 2-ethylhexyloxyethanol); ethers such as dialkylene glycol alkyl ethers (e.g. diethylene glycol monoethyl ether, dipropylene glycol monopropyl ether, tripropylene glycol monomethyl ether); esters such as lactates and acetates and in particular dialkyl glycol alkyl ether acetates (e.g. diethylene glycol monoethyl ether acetate); alkyl succinate (e.g. diethyl succinate), alkyl glutarate (e.g. diethyle glutarate), and alkyl adipate (e.g. diethyl adipate).

For many applications, such as PDP barrier ribs, it is desirable for debinding of the green state microstructures to be substantially complete before firing. Additionally, debinding is often the longest and highest temperature step in thermal processing. Thus, it is desirable for the slurry or paste to be capable of debinding relatively quickly and completely and at a relatively low temperature.

While not wishing to be bound by any theory, debinding can be thought of as being kinetically and thermodynamically limited by two temperature-dependent processes, namely diffusion and volatilization. Volatilization is the process by which decomposed binder molecules evaporate from a surface of the green state structures and thus leave a porous network for egress to proceed in a less obstructed manner. In a single-phase resin binder, internally trapped gaseous degradation products can blister and/or rupture the structure. This is more prevalent in binder systems that leave a high level of carbonaceous degradation products at the surface that can form an impervious skin layer to stop the egress of binder degradation gases. In some cases where single-phase binders are successful, the cross sectional area is relatively small and the binder degradation heating rate is sufficiently long to prevent a skin layer from forming.

The rate at which volatilization occurs depends on temperature, an activation energy for volatilization, and a frequency or sampling rate. Because volatilization occurs primarily at or near surfaces, the sampling rate is typically proportional to the total surface area of the structures. Diffusion is the process by which binder molecules migrate to surfaces from the bulk of the structures. Due to volatilization of binder material from the surfaces, there is a concentration gradient which tends to drive binder material toward the surfaces where there is a lower concentration. The rate of diffusion depends on, for example, temperature, an activation energy for diffusion, and a concentration.

Because volatilization is limited by the surface area, if the surface area is small relative to the bulk of the microstructures, heating too quickly can cause volatile species to be trapped. When the internal pressure gets large enough, the structures can bloat, break or fracture. To curtail this effect, debinding can be accomplished by a relatively gradual increase in temperature until debinding is complete. A lack of open channels for debinding, or debinding too quickly, can also lead to a higher tendency for residual carbon formation. This in turn may necessitate higher debinding temperatures to ensure substantially complete debinding. When debinding is complete, the temperature can be ramped up more quickly to the firing temperature and held at that temperature until firing is complete. At this point, the articles can then be cooled.

The diluent enhances debinding by providing shorter pathways for diffusion and increased surface area. The diluent preferably remains a liquid and phase separates from the binder when the binder is cured or otherwise hardened. This creates an interpenetrating network of pockets of diluent dispersed in a matrix of hardened binder material. The faster that curing or hardening of the binder material occurs, the smaller the pockets of diluent will be. Preferably, after hardening the binder, a relatively large amount of relatively small pockets of diluent are dispersed in a network throughout the green state structures. During debinding, the low molecular weight diluent can evaporate quickly at relatively low temperatures prior to decomposition of the other high molecular weight organic components. Evaporation of the diluent leaves behind a somewhat porous structure, thereby increasing the surface area from which remaining binder material can volatilize and decreasing the mean path length over which binder material must diffuse to reach these surfaces. Therefore, by including the diluent, the rate of volatilization during binder decomposition is increased by increasing the available surface area, thereby increasing the rate of volatilization for the same temperatures. This makes pressure build up due to limited diffusion rates less likely to occur. Furthermore, the relatively porous structure allows pressures that are built up to be released easier and at lower thresholds. The result is that debinding can typically be performed at a faster rate of temperature increase while lessening the risk of microstructure breakage. In addition, because of the increased surface area and decreased diffusion length, debinding is complete at a lower temperature.

The diluent is not simply a solvent compound for the binder. The diluent is preferably soluble enough to be incorporated into the binder in the uncured state. Upon curing of the binder of the slurry or paste, the diluent should phase separate from the monomers and/or oligomers participating in the cross-linking process. Preferably, the diluent phase separates to form discrete pockets of liquid material in a continuous matrix of cured binder, with the cured binder binding the particles of the glass frit or ceramic material of the slurry or paste. In this way, the physical integrity of the cured green state microstructures is not greatly compromised even when appreciably high levels of diluent are used (i.e., greater than about a 1:3 diluent to resin ratio).

Preferably the diluent has a lower affinity for bonding with the inorganic material of the slurry or paste than the affinity for bonding of the binder with the inorganic material. When hardened, the binder should bond with the particles of the inorganic material. This increases the structural integrity of the green state structures, especially after evaporation of the diluent. Other desired properties for the diluent will depend on the choice of inorganic material, the choice of binder material, the choice of cure initiator (if any), the choice of the substrate, and other additives (if any). Preferred classes of diluents include glycols and polyhydroxyls, examples of which include butanediols, ethylene glycols, and other polyols.

In addition to inorganic powder, binder, and diluent, the slurry or paste can optionally include other materials. For example, the slurry or paste can include an adhesion promoter to promote adhesion to the substrate. For glass substrates, or other substrates having silicon oxide or metal oxide surfaces, a silane coupling agent is a preferred choice as an adhesion promoter. A preferred silane coupling agent is a silane coupling agent having three alkoxy groups. Such a silane can optionally be pre-hydrolyzed for promoting better adhesion to glass substrates. A particularly preferred silane coupling agent is a silano primer such as sold by 3M Company, St. Paul, Minn. under the trade designation “Scotchbond Ceramic Primer”. Other optional additives can include materials such as dispersants that aid in mixing the inorganic material with the other components of the slurry or paste. Optional additives can also include surfactants, catalysts, anti-aging components, release enhancers, and so on.

Generally, the methods of the present invention typically use a mold to form the microstructures. The mold is preferably a flexible polymer sheet having a smooth surface and an opposing microstructured surface. The mold can be made by compression molding of a thermoplastic material using a master tool that has a microstructured pattern. The mold can also be made of a curable material that is cast and cured onto a thin, flexible polymer film. The molds may have curved surfaces connecting the barrier regions and land regions such as described in U.S. patent application Publication No. 2003/0100192-A1. Further the material of the land portions may be continuous with the material of the barrier portions.

The microstructured mold can be formed, for example, according to a process like the processes disclosed in U.S. Pat. No. 5,175,030 (Lu et al.) and U.S. Pat. No. 5,183,597 (Lu), incorporated herein by reference. The formation process includes the following steps: (a) preparing an oligomeric resin composition; (b) depositing the oligomeric resin composition onto a master negative microstructured tooling surface in an amount barely sufficient to-fill the cavities of the master; (c) filling the cavities by moving a bead of the composition between a preformed substrate and the master, at least one of which is flexible; and (d) curing the oligomeric composition. A preferred master is a metallic tool. If the temperature of the curing and optional simultaneous heat treating step is not too great, the master can also be constructed from a thermoplastic material, such as a laminate of polyethylene and polypropylene.

The oligomeric resin composition of step (a) is preferably a one-part, solvent-free, radiation-polymerizable, crosslinkable, organic oligomeric composition, although other suitable materials can be used. The oligomeric composition is preferably one which is curable to form a flexible and dimensionally-stable cured polymer. The curing of the oligomeric resin preferably occurs with low shrinkage.

The oligomeric resin composition of step (a) preferably is a one-part, solvent-free, (e.g. radiation polymerizable) crosslinkable, organic oligomeric composition. The oligomeric composition is preferably one which is curable to form a flexible and dimensionally-stable cured polymer. The curing of the oligomeric resin preferably occurs with low shrinkage. The Brookfield viscosity of the oligomeric resin is typically at least 10 cps and typically no greater than 35,000 cps and more preferably has a viscosity in the range of 50 cps to 10,000 cps.

Preferred oligomeric compositions comprise at least one acryl oligomer and at least one acryl monomer. As used herein acryl includes the species (meth)acryl. The acryl monomer(s) and urethane acrylate oligomer(s) preferably have a glass transition temperature (Tg) of about −80 to about 0° C., respectively, meaning that the homopolymers thereof have such glass transition temperatures.

Examples of acryl monomers having a glass transition temperature of about −80 to about 0° C. and include for example polyether acrylate, polyester acrylate, acrylamide, acrylonitrile, acrylic acid, acrylic acid ester, etc. Acryl oligomers having a glass transition temperature of about −80 to about 0° C. include for example urethane acrylate oligomer, polyether acrylate oligomer, polyester acrylate oligomer, and epoxy acrylate oligomer. For example, urethane acrylate oligomer and acryl monomer can be combined respectively in amounts of about 10 to about 90 wt-% and more preferably in amount of about 20 to about 80 wt-%. Preferred oligomeric resin compositions are described in PCT Publication No. WO2005/021260; PCT Publication No. WO2005/021260 and U.S. patent application Ser. No. 11/107554, filed Apr. 15, 2005; each of which are incorporated herein by reference.

Polymerization can be accomplished by typical means, such as heating in the presence of free radical initiators, irradiation with ultraviolet or visible light in the presence of suitable photoinitiators, and irradiation with electron beam. One method of polymerization is by irradiation with ultraviolet or visible light in the presence of photoinitiator at a concentration of about 0.1 percent to about 1 percent by weight of the oligomeric composition. Higher concentrations can be used but are not normally needed to obtain the desired cured resin properties.

Various materials can be used for the base (substrate) of the patterned mold. Typically the material is substantially optically clear to the curing radiation and has enough strength to allow handling during casting of the microstructure. In addition, the material used for the base can be chosen so that it has sufficient thermal stability during processing and use of the mold. Polyethylene terephthalate or polycarbonate films are preferable for use as a substrate in step (c) because the materials are economical, optically transparent to curing radiation, and have good tensile strength. Substrate thicknesses of 0.025 millimeters to 0.5 millimeters are preferred and thicknesses of 0.075 millimeters to 0.175 millimeters are especially preferred. Other useful substrates for the microstructured mold include cellulose acetate butyrate, cellulose acetate propionate, polyether sulfone, polymethyl methacrylate, polyurethane, polyester, and polyvinyl chloride. The surface of the substrate may also be treated to promote adhesion to the oligomeric composition.

Examples of suitable polyethylene terephthalate based materials include: photograde polyethylene terephthalate; and polyethylene terephthalate (PET) having a surface that is formed according to the method described in U.S. Pat. No. 4,340,276, incorporated herein by reference.

Various other aspects that may be utilized in the invention described herein are known in the art including, but not limited to each of the following patents that are incorporated herein by reference: U.S. Pat. No. 6,247,986; U.S. Pat. No. 6,537,645; U.S. Pat. No. 6,713,526; WO 00/58990, U.S. Pat. No. 6,306,948; WO 99/60446; WO 2004/062870; WO 2004/007166; WO 03/032354; WO 03/032353; WO 2004/010452; WO 2004/064104; U.S. Pat. No. 6,761,607; U.S. Pat. No. 6,821,178; WO 2004/043664; WO 2004/062870; PCT Application No. US04/33170, filed Oct. 8, 2004; PCT Application No. US04/26701, filed Aug. 17, 2004; PCT Application No. US04/26845, filed Aug. 18, 2004; PCT Application No. US04/23472 filed Jul. 21, 2004; PCT Application No. US04/32801 filed Oct. 6, 2004; PCT Application No. US04/43471 filed Dec. 22, 2004; U.S. patent applications Ser. Nos. 60/604556, 60/604557, 60/604558 and 60/604559, each filed Aug. 26, 2004.

Advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

A glass frit slurry formulation suitable for use in these examples includes 80 parts by weight glass powder available from Asahi Glass Co., Tokyo, Japan under the trade designation “RFWW030” that contains lead borosilicate glass frit with refractory fillers such as TiO₂ and Al₂O₃. To the glass powder is added 8.034 parts by weight BisGMA (bisphenol-a diglycidyl ether dimethacrylate), available form Sartomer Company, Inc., Exton, Pa., and 4.326 parts by weight TEGDMA (triethylene glycol dimethacrylate), available from Kyoeisha Chemical Co., Ltd., Japan, to form the curable fugitive binder. As a diluent, 7 parts by weight of 1,3 butanediol (Aldrich Chemical Co., Milwaukee, Wis.) is used. In addition, 0.12 parts by weight POCAII (phosphate polyoxyalkyl polyol), obtained from 3M Company, St. Paul, Minn. is added as a dispersant, 0.16 parts by weight A174 Silane (Aldrich Chemical Co., Milwaukee, Wis.) is added as a silane coupling agent, and 0.16 parts by weight cure initiator available from Ciba Specialty Chemicals, Basel, Switzerland under the trade designation “Irgacur 819”. In additional, 0.20 parts defoamer, available from BYK Chemie USA, Wallingford, Conn. under the trade designation “BYK A555” is added.

All liquid ingredients and the photoinitiator are combined in a stainless steel mixing container. The ingredients are blended using a cowles blade (VWR Scientific Products, West Chester, Pa.) driven by a pneumatic motor. With the mixing blade running, the solid ingredients are slowly added. After all the ingredients are incorporated, the mixture was blended for an additional 5 minutes. The slurry is transfered to a high-density polyethylene container charged with ½ inch cylindrical high density aluminum oxide milling media. Milling is performed using a paint conditioner (Red Devil Model 5100, Union, N.J.) for 30 minutes. The slurry is then drained from the ball mill. Finally, the slurry is milled using a 3-roll mill (Model 2.5×5 TRM, Charles Ross & Son Company, Haupauge, N.Y.) at 60° C.

### Example 1

A transfer sheet is provided having two separable layers. The first layer is a rigid support and the second layer is a flexible film.

With reference to FIG. 2, the rigid support is a 25 mm thick aluminum plate that is 1.5 m×2.5 m and has been machined to a depth of 10 mm on both sides leaving grids of supporting ribs. A 5 mm thick aluminum plate has been bonded to the supporting ribs creating a flat surface on the top and bottom. The edge of the rigid support where the film slides has a sharp 500 p radius edge and a 45 degree taper.

There are 100 p diameter holes provided at the top and bottom surfaces of the rigid support. Fittings are attached to the edges of the support so that the flexible film can be selectively pulled by vacuum to the top or bottom surfaces of the support. A valve allows compressed air to alternatively be introduced to the fittings so that the flexible film can move easily across either or both surfaces.

A 5 mil polyethylene, having a release coating on one side, is employed as the flexible film in the apparatus of FIGS. 4A-4D.

A coating system is used to place 4 discrete patches of slurry that are each 523 mm by 930 mm (appropriately sized to produce four 42 plasma display panels) having a uniform thickness of 165 microns in predetermined locations on the top surface of the transfer sheet.

The apparatus of FIGS. 4A-4D can be use to transfer the discrete patches of slurry onto the electrode patterned glass panel as previously described.

Four (e.g. flexible polymeric) molds are then pressed into the patches of slurry such that the barrier rib structures are aligned with the electrode patterns. After molding, the coated substrate is exposed to a blue light source to harden the glass frit slurry. Curing is performed using a blue light source at 1.5 inch (about 3.8 cm) above sample surface. The light source is constructed from 10 super-actinic fluorescent lamps (Model TLDK 30W/03, Philips Electronics N.V., Einhoven, Netherlands) spaced at 2 inches (about 5.1 cm) apart that can provide light in a wavelength range of about 400 to 500 nm. Curing time is typically 30 seconds.

The four mold tools are removed. The substrate is moved with a part handling system. The glass substrate with cured structures will be sintered in air according to the following thermal cycle: 3° C./min to 300° C., 5° C./min to 560° C., soak for 20 minutes, and cooled at 2-3° C./min to ambient.

What is claimed is:

1. A method of making barrier ribs for a plasma display panel comprising: providing a transfer sheet;
coating the transfer sheet with at least one discrete coating of a curable composition comprising
at least one inorganic particulate material,
at least one curable organic binder,
and at least one diluent;
transferring the discrete coating onto a substrate; p1 contacting the discrete coating with a mold suitable for forming barrier ribs;
curing the curable composition; and
removing the mold.

2. The method of claim 1 wherein the transfer sheet is coated with at least two discrete coatings.

3. The method of claim 1 wherein the transfer sheet is provided on a substantially planar rigid support.

4. The method of claim 1 wherein the transfer sheet is provided on a roll.

5. The method of claim 1 wherein the step of transferring the discrete coating comprises contacting the substrate with the coated transfer sheet while the transfer sheet remains horizontal and rotating the coated transfer sheet together with the substrate such that substrate is beneath the transfer sheet.

6. The method of claim 1 wherein the step of transferring the discrete coating comprising transferring a coating from a transfer sheet to a substrate in a rotational framework.

7. The method of claim 1 wherein each discrete coating is an area corresponding to a single plasma display panel.

8. The method of claim 1 wherein each discrete coating has an area ranging from about 1 cm² to about 2 m².

9. The method of claim 1 wherein the transfer sheet comprises a flexible film and a rigid support layer.

10. The method of claim 1 wherein the flexible film is removed concurrently with removing the rigid support layer.

11. The method of claim 1 wherein the substrate is a glass panel optionally comprising an electrode pattern

12. The method of claim 1 wherein the discrete coatings are provided with a template.

13. The method of claim 1 wherein the mold is transparent.

14. The method of claim 1 wherein the curable composition is cured through the mold, cured through the substrate, or a combination thereof.

15. The method of claim 1 wherein the mold is flexible.

16. The method of claim 1 wherein the method is at least semi-automated.

17. The method of claim 1 wherein the curable composition comprises diluent is an amount of at least 2 wt-%, at least 5 wt-% or at least 10 wt-%.

18. The method of claim 1 wherein the slurry has a viscosity of less than 20,000 cps less than 5,000 cps.

19. The method of claim 1 wherein two or more discrete coatings are transferred onto a single glass panel.

20. A method of making an article comprising:
providing a transfer sheet;
coating the transfer sheet with at least one discrete coating of a curable material;
transferring the discrete coating onto a substrate; and
contacting the discrete coating with a microstructured mold surface;
curing the curable material; and
removing the mold.
